(19) United States
(12) Patent Application Publication
(10) Pub. No.: US 2011/0176200 A1
(43) Pub. Date: Jul. 21, 2011

(54) Delay-Line-Interferometer for Integration with Balanced Receivers

(75) Inventor: Zhiqiang Chen, Fremont, CA (US)

(73) Assignee: W2 OPTRONICS INC, Fremont, CA (US)

(21) Appl. No.: 13/008,031

(22) Filed: Jan. 18, 2011

Related U.S. Application Data
(63) Continuation-in-part of application No. 12/888,414, filed on Sep. 23, 2010.
(60) Provisional application No. 61/295,766, filed on Jan. 18, 2010.

(51) Int. Cl. G02F 2/00

(52) U.S. Cl. 359/325

(57) ABSTRACT

This invention provides a DPSK demodulator and a DQPSK demodulator. Both of the demodulators are based on polarization delay-line interferometers. They can be integrated with photodetectors in fiber-optic communication systems. The demodulators consist of polarization beam shifter, polarization beam splitter and wave plates. Coupling of the demodulators with photodetectors can be through free space or fibers. Time delay generated in the interferometer can be controlled with a phase shifter, using either thermal, piezoelectric, mechanical or electrical means. Examples of phase shifter using a piezo bender and an actuator respectively are also disclosed.

This application claims priority to U.S. Provisional Patent Application Ser. No. 61/295,766, filed on Jan. 18, 2010, titled “Delay-Line-Interferometer for Integration with Balanced Receivers.” This application is also a continuation in part of U.S. patent application Ser. No. 12/888,414, filed on Sep. 23, 2010.

### BACKGROUND OF INVENTION

1. Field of Invention

Embodiments of the invention relate generally to optical communication systems and components, and more particularly, to an optical demodulator for high speed receivers.

2. Description of the Invention

In high speed fiber-optic communication systems, Differential Phase Shift Keying (DPSK) and Differential Quadratic Phase Shift Keying (DQPSK) modulation formats can be used to lower the penalty of dispersion and nonlinear effects. To decode DPSK or DQPSK signals, demodulators based on delay-line interferometers are needed before receivers.

The delay-line interferometers can be a Michelson interferometer, a Mach-Zehnder interferometer, or a polarization interferometer. Most conventional fiber-optic delay-line interferometers employ a beam splitter (BS) to split the input beam into two arms. These two beams are then recombined at the same or another beam splitter by using minors to provide the required difference in light path. When a light path length difference exists between the two interfering beams, these conventional interferometers provide a sinusoidal spectral transmission function. Under the appropriate conditions, the transmission maxima and minima can be tuned to match the ITU frequency channels. Thus, such interferometers are usually employed in designing spectral interleavers for Dense Wavelength Domain Multiplexing (DWDM) applications.

Because of the light path difference, there is a time delay difference existing between the two arms. If the time delay difference of the interferometer in the two arms equals one period of the modulated pulses, the interferometer can be used in a DPSK demodulator or DQPSK demodulator. There are several approaches to implement such a demodulator, including free space Michelson interferometers, free space polarization interferometers and planar waveguide Mach-Zehnder interferometer.

US Patent Application Ser. No. 2007/0070505 describes a demodulator using a nonpolarization beamsplitter. US Patent Application Ser. No. 2006/0140695A1 uses a Michelson interferometer to implement a DQPSK demodulator. In these nonpolarization interferometer, a 50:50 beamsplitter is a critical part to maintain a low polarization dependent loss(PDL) and low polarization dependent frequency shift(PDFS).

Polarization based interferometers use polarization components to split beams, generate light path difference, and recombine beams. US Patent Application Ser. No. 2006/0171718A1 proposed a polarization based DQPSK demodulator. Light Path difference is generated with a piece of polarization maintaining (PM) fiber.

However, all nonpolarization approaches require extremely low birefringence in the light paths. Otherwise, the device will show high polarization dependence in insertion loss and frequency shift. The polarization based interferometer disclosed hereafter is more advantageous due to its high performance in polarization dependence and extinction ratio. U.S. patent application Ser. No. 12/888,414 disclosed a DPSK demodulator based on polarization components, including both beam splitting and beam recombining. The DPSK and DQPSK demodulators presented in this application is an extension of the application U.S. Ser. No. 12/888,414.

In a delay-line interferometer based DPSK demodulator, the light path difference between the arms is exactly the time for one bit of signal. After passing through the demodulator light in a coming signal interferences with the light in the following signal. Because the signals are phase keyed, after interference, phase-keyed signals are converted into intensity-keyed signals.

DQPSK modulation is a format as an extension of the DPSK modulation. Generally speaking, a DQPSK demodulator can be constructed with a pair of DPSK demodulators. In such a DQPSK demodulator, phase of the four outputs of the two DPSK demodulators need to be maintained π/4 apart.

### SUMMARY OF THE INVENTION

The object of this invention is to provide a compact delay-line interferometer that can be used in DPSK and DQPSK demodulators, by using polarization components. Furthermore, the realized demodulators can be used as either discrete components or integrated with balanced detectors. For the DQPSK demodulator, one more beam splitter is used to separate light intensity evenly into two sets of DPSK demodulators. The two sets of DPSK demodulators share the following components:
1. A polarization beam splitter to divide light into two interference arms.
2. A phase shifter that controls the path-length difference. The phase shifter can be air-spaced double minors, a solid substrate with separated reflecting surfaces, or a solid substrate with anti-reflection coatings.
3. A polarization beam splitter to combine light from two interference arms and redirect the light into two output ports.
4. Several beam shifters that are employed to split a beam of unpolarized light into two independent components of orthogonal polarization states, and/or to combine two polarization components into a beam of unpolarized light.
5. Several wave plates to change the polarization states of the light beams.

### BRIEF DESCRIPTION OF THE DRAWINGS

In order to illustrate the embodiments and principle of the invention the following drawings are included in the disclosure.

FIG. 1 shows the common configuration of the DPSK demodulator that can be integrated with balanced detectors through fibers.

### 1.1—Collimator

### 1.2, 1.13, 1.16—Beam Shifter

### 1.3, 1.14, 1.15—Half-Wave Plate

### 1.4, 1.8, 1.11—Quarter-Wave Plate

### 1.5—Polarization Beam Splitter

### 1.7—Polarization Beam Splitting Interface

### 1.6, 1.9, 1.12—Reflector

### 1.10—Phase Shifter

### 1.17—Prism

### 1.18—Lens

### 1.19—Fibers

### 1.20—Balanced Detectors

FIG. 2 shows the first embodiment of the DQPSK demodulator.

### 2.1—Collimator

### 2.2, 2.5, 2.18, 2.25—Beam Shifter

### 2.3, 2.17, 2.23, 2.24—Half-Wave Plate

### 2.4, 2.6, 2.10, 2.15—Quarter-Wave Plate

### 2.9, 2.16—Polarization Beam Splitter

### 2.7—Polarization Beam Splitting Interface

### 2.8, 2.14, 2.22—Reflector

### 2.11—Tuning Plate

### 2.12—Piezo Bender

### 2.13—Phase Shifter

### 2.19, 2.26—Prism

### 2.20, 2.27—Lens

### 2.21—Dual Balanced Detectors

FIG. 3 shows the second embodiment of the DQPSK demodulator.

### 3.1—Collimator

### 3.2, 3.5, 3.19, 3.26—Beam Shifter

### 3.3, 3.18, 3.24, 3.25—Half-Wave Plate

### 3.4, 3.6, 3.11, 3.16—Quarter-Wave Plate

### 3.10, 3.17—Polarization Beam Splitter

### 3.8—Polarization Beam Splitting Interface

### 3.7, 3.9, 3.14, 3.23—Reflector

### 3.12—Tuning Wedge Pair

### 3.13—Piezo Actuator

### 3.15—Phase Shifter

### 3.20, 3.27—Prism

### 3.21, 3.28—Lens

### 3.22—Fibers

### 3.29—Dual Balanced Detectors

### DETAILED DESCRIPTION OF THE INVENTION

The delay-line interferometer based DPSK demodulator has a single fiber input and dual fiber outputs, or balanced detector outputs. There are two paths from the input to each of the output respectively. If these two paths differ by a whole number of wavelengths there is constructive interference and a strong signal at one output port, and destructive interference at the other output port.

### Embodiment for DPSK Demodulator

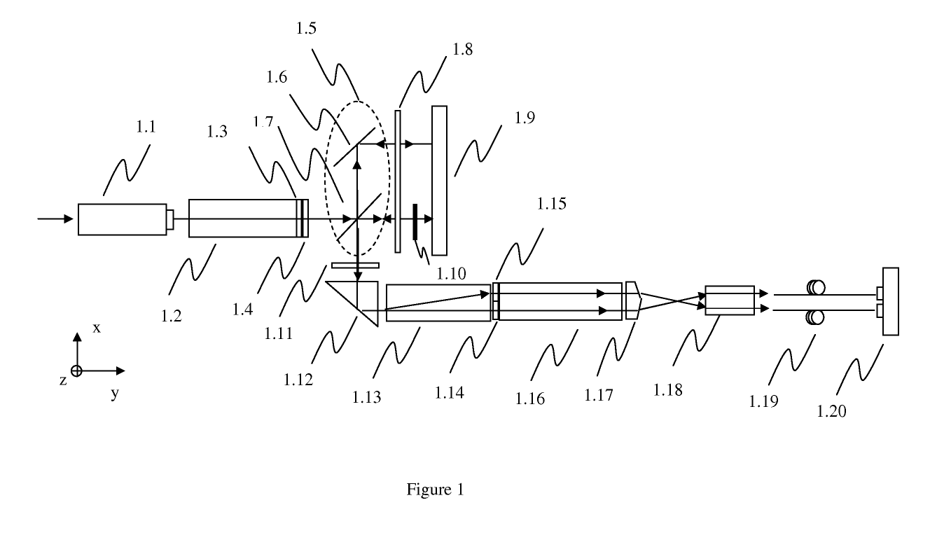

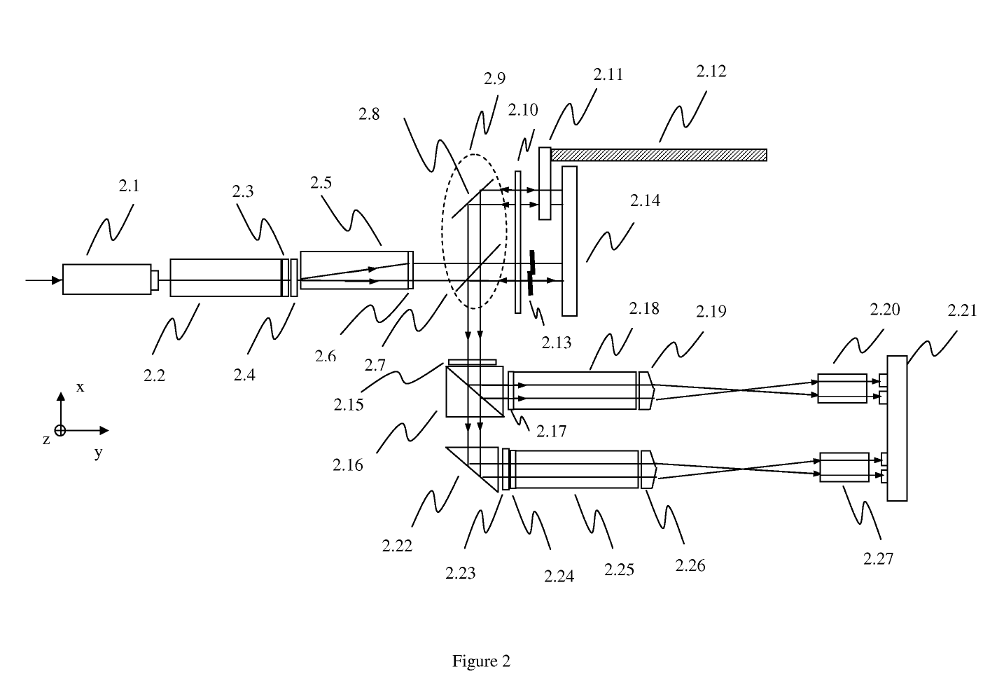

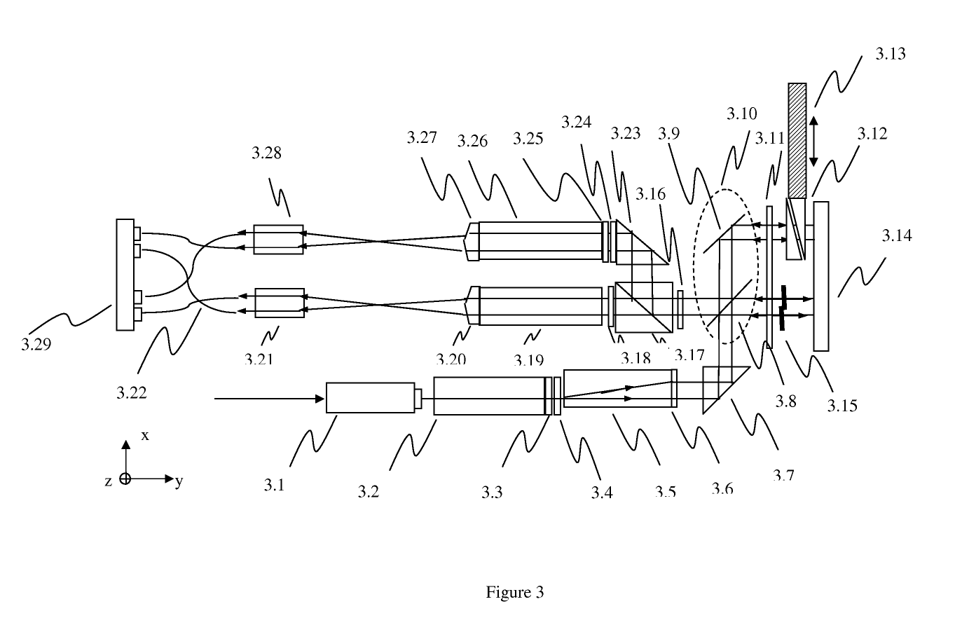

Referring to FIG. 1, unpolarized incident light from collimator 1.1 is separated into two polarization components by YVO4 beam shifter 1.2 in z-direction. Then one of the two polarization components is rotated 90 degrees by half-wave plate 1.3. Therefore after half-wave plate 1.3 and quarter-wave plate 1.4, each of the two components is further divided into two arms in x-y plane by polarization beam splitter 1.5. Here 1.7 serves as a polarization beam splitting interface. Referring to FIG. 4, unpolarized incident light is separated into two polarization components by YVO4 beam shifter 4.2 in z-direction. In order to maintain the parallelism of the two beams after the polarization splitter, the beam splitting interface 1.7 and reflection surface 1.6 are required to be parallel. Then quarter-wave plate 1.8 turns the light's polarization state by 90 degrees after a double pass. The light path difference between the two arms is dependent on the spacing among 1.5's beam splitting interface 1.7, reflector 1.6 and mirror 1.9, as well as the thickness of phase shifter 1.10. Light beams reflected from mirror 1.9 in the two arms are then combined by 1.5 and directed to beam shifter 1.13 after a quarter-wave plate 1.11. Quarter-wave plate 1.11 in front of polarization beam shifter 1.13 turns the linearly-polarized light beams from the two arms into circularly-polarized beams. Due to the light path difference between the two arms, after 1.13, interference will occur. Through wave plates 1.14 and 1.15, and beam shifter 1.16, the z-direction separated two components are recombined. In order to couple the light into two balanced detectors 1.20, a prism 1.17, a focusing lens 1.18, a two fibers 1.19 are employed.

In such a polarization based optical interferometer, the intensity of one of the output ports is a sinusoidal function of frequency. We note that the intensity is a sinusoidal function of the optical frequency with transmission maxima occur at

f=mC/L

where m is integer, C is the spped of light, L is the optical path difference between the two arms.

The spectral separation between the maxima, i.e., the free-Spectral-range (FSR) is given by

FSR=C/L

For applications in DPSK and DQPSK demodulators, L should be tuned to match the one-bit delay requirement. For example, if the modulation frequency is 100 Gb/s, the one bit delay will be 10 ps. To match this delay the round trip optical path difference should be around 3 mm in air.

The optical light path difference L determines the channel spacing of the interferometer. By thermally or mechanically changing L, the resonant frequency of the device can be made tunable.

### First Embodiment for DQPSK Demodulator

The first embodiment of the polarization based DQPSK demodulator is shown in FIG. 2. Just like the DPSK embodiment shown in FIG. 1, it includes a polarization beam splitter, several beam shifters and wave plates. The combination of a quarter wave plate and a beam shifter divide the input light before the polarization beam splitter into two parallel paths, with an intensity ratio of 50:50. Therefore, two sets of demodulators are formed sharing the same polarization beam splitter.

In FIG. 2, unpolarized incident light is separated into two polarization components by YVO4 beam shifter 2.2 in z-direction. One of the two polarization components is rotated 90 degrees by half-wave plate 2.3. After half-wave plate 2.3 and quarter-wave plate 2.4, each of the two components is further divided into two arms in x-direction by beam shifter 2.5. Here 2.5 serves as a beam splitter that divides the light into two sets of DPSK demodulators in parallel. After a quarter-wave plate 2.6, the light beams are further divided into two arms in the x-y plane by the polarization beam splitter 2.9. A quarter-wave plate 2.10 located between polarization beam splitter 2.9 and minor 2.14 are used to rotate light's polarization state by 90 degrees after a double pass. Because of the rotation of polarization state, light beams reflected from minor 2.14 are directed to polarization beam splitter 2.16. A quarter-wave plate 2.15 in front of polarization beam splitter 2.16 turns the linearly-polarized light beams from the two arms into circularly-polarized beams. Due to the light path difference between the two arms, after 2.16, interference will occur. Phase shifter 2.11 in one of the two arms is used to change the light path difference between the two arms. Meanwhile, phase shifter 2.13 is used to maintain the 90 degree phase difference between the two sets of DPSK demodulators. Through wave plates 2.17 and beam shifter 2.18, for light beams reflected by 2.16, the z-direction separated two components are recombined. Similarly, the z-direction separated two components are recombined for the light beams transmitted through 2.16. In order to couple the light into two sets of balanced detectors 2.21, prisms 2.19, 2.26 and focusing lens 2.20, 2.27 are employed.

The phase shifter 2.11 is actually an optical plate mounted on a piezo bender 2.12. When a voltage is applied onto the piezo bender, the plate is tilted. As the angle of incidence is changed, light path length is changed. With a voltage of 150 voltage, a large tilting angle can be obtained to ensure a tuning range up to 1.5 FSR. An example of the piezo bender is a multiplayer piezo actuator with a response time in millisecond range. Multilayer piezoelectric components are manufactured from ceramic layers of only about 50 μm thickness. By applying an AC voltage cross the piezo bender, dithering can be implemented using the same phase shifter.

### Second Embodiment for DQPSK Demodulator

In FIG. 3, unpolarized incident light is separated into two polarization components by YVO4 beam shifter 3.2 in z-direction. One of the two polarization components is rotated 90 degrees by half-wave plate 3.3. After half-wave plate 3.3 and quarter-wave plate 3.4, each of the two components is further divided into two arms in x-direction by beam shifter 3.5. Here 3.5 serves as a beam splitter that divides the light into two sets of DPSK demodulators in parallel. After a quarter-wave plate 3.6, the light beams are further divided into two arms in the x-y plane by the polarization beam splitter 3.10. A quarter-wave plate 3.11 located between polarization beam splitter 3.10 and mirror 3.14 are used to rotate light's polarization state by 90 degrees after a double pass. Because of the rotation of polarization state, light beams reflected from minor 3.14 are directed to polarization beam splitter 3.17. A quarter-wave plate 3.16 in front of polarization beam splitter 3.17 turns the linearly-polarized light beams from the two arms into circularly-polarized beams. Due to the light path difference between the two arms, after 3.17, interference will occur. Phase shifter 3.12 in one of the two arms is used to change the light path difference between the two arms. Meanwhile, phase shifter 3.15 is used to maintain the 90-degree phase difference between the two sets of DPSK demodulators. Through wave plates 3.18 and beam shifter 3.19, for light beams transmitted by 3.17, the z-direction separated two components are recombined. Similarly, for the light beams reflected from 3.17, the z-direction separated two components are also recombined with the usage of 3.24, 3.25 and 3.26. In order to couple the light into two sets of balanced detectors 3.29, two prisms 3.20, 3.27, two focusing lens 3.21, 3.28 and four fibers 3.22 are employed.

Here the phase shifter 3.12 is actually a pair of optical wedges. One of the wedges is fixed on the base plate. And the other one is mounted on the end of a piezo actuator 3.13. The two wedges have the same wedge angle. So that they act as a flat optical plate when they are combined. When a voltage is applied onto the piezo actuator, the wedge can moved back or forth. Thus the light path length can be varied without changing the light beam's propagation direction.

We claim that:

1. An optical DPSK demodulator composed of polarization optical components, including beam shifters, waveplates, beam splitters and beam combiners.

2. From input to output, the DPSK demodulator said in (1) sequentially composing means for splitting nonpolarized light into two linear polarization states;
means for splitting polarized light beams into two paths;
means for generating a controllable length difference between two paths;
means for recombining light from two paths;
means for recombining light in two linear polarization states into nonpolarized light;
means for directing recombined light into two output ports;

3. The means in (2) for splitting nonpolarized light into polarized states is a birefringent crystal.

4. The means in (2) for splitting polarized light beams into two paths is a polarization beam splitter based on dielectric films.

5. The means in (2) for controlling the light path difference between the two paths is a medium that its optical thickness can be varied through refractive index change, thickness change, incident angle change, or position change.

6. The means in (2) for recombining polarized light beams from two paths is the same polarization beam splitter said in (4) or another polarization beam splitter based on dielectric films.

7. The means in (2) means for recombining light in two linear polarization states into nonpolarized light is a birefringent crystal.

8. The means in (2) for directing recombined light into two output ports includes a prism that generates a cross angle between the two output beams in order to couple the light beams into two fibers through the same focusing lens.

9. A DPSK demodulator that can be connected with balanced detectors through fibers or fiber ribbon cables.

10. An optical DQPSK demodulator based on the DPSK demodulator said in (1)-(9) includes a beam shifter which divides the input light beam into two sets of DPSK demodulators.

11. The resulted two sets of the DPSK demodulators said in (10) share the same phase shifter.

12. The DPSK demodulator said in (10) further includes phase shifters or light path length tuners. The light path length difference between the two arms will determine the time delay and transmission frequency of the demodulator.

13. The phase shifter said in (12) is an optical plates that can be tilted with a piezo bender.

14. The phase shifter said in (12) is a pair of optical wedges. One of these wedges is mounted at the end of a piezo actuator. Relative movement between the two wedges can introduce a phase shift between the two arms.

15. The DQPSK demodulator said in (10) further includes a phase shifter that is used to adjust and maintain the 90-degree phase difference between the two sets of DPSK demodulators.

16. Phase shifter said in (12) is based on either thermal, piezoelectric, mechanical or electrical means.

17. Coupling of light from the DQPSK demodulators to photodetectors can be either through free space or through fibers.
